(19) United States
(12) Patent Application Publication
(10) Pub. No.: US 2019/0335078 A1
(43) Pub. Date: Oct. 31, 2019

(54) DETECTION SYSTEM AND ASSOCIATED DETECTION METHOD FOR DETECTING OCCURRENCE OF ARCING PHENOMENON

(71) Applicant: MACRONIX INTERNATIONAL CO., LTD., Hsinchu (TW)

(72) Inventor: Shih-Hung CHEN, Hsinchu County (TW)

(21) Appl. No.: 15/966,089

(22) Filed: Apr. 30, 2018

(51) Int. Cl. H04N 5/235; G08B 5/36; H04N 5/76

(52) U.S. Cl. CPC H04N 5/2353; H04N 5/2354; H04N 5/76; G08B 5/36

(57) ABSTRACT

A detection system and associated detection method for detecting an arcing phenomenon in a chamber are provided. In the chamber, a plurality of semiconductor chips are manufactured on at least one wafer. The detection system includes at least one optical sensor and a control circuit. Being configured for detecting the intensity of the light signal in the chamber, the at least one optical sensor is placed in the chamber. Accordingly, the optical sensor generates a plurality of intensity detected results, wherein the light signal continuously lasts in the chamber while the plurality of semiconductor chips are manufactured. The control circuit is in communication with the optical sensor. Then, the control circuit identifies whether the arcing phenomenon occurred according to the plurality of intensity detected results.

### BACKGROUND OF THE INVENTION

### Field of the Invention

The invention relates in general to a detection system and associated detection method, and more particularly to a detection system and associated detection method for detecting the occurrence of arcing phenomenon in a chamber for manufacturing semiconductor chips.

### Description of the Related Art

FIG. 1 is a schematic diagram illustrating occurrence of arcing phenomenon during manufacture process of semiconductor chips. When manufacturing the semiconductor chips 13, one or more wafers 11 are placed in a chamber 10, and many processes including plasma are required. However, the plasma may result in randomly distributed charges on the surface of the wafers 11. Once the charges 15 gradually accumulate to a certain degree, voltage potential caused by the charges 15 may result in arcing phenomenon. The arcing phenomenon may induce huge damage to the semiconductor chips 13. Moreover, for semiconductor products having many layers or complex manufacture processes, the occurrence chance of the arcing phenomenon becomes higher.

Typically, fault detection and classification (hereinafter, FDC) is used in manufacturing semiconductors, but the typical FDC generates 1 detection record per second. On the other hand, the arcing phenomenon may last shorter than 100 us. Therefore, the conventional FDC is too slow to detect the arcing phenomenon.

As illustrated above, the manufacturing processes of the semiconductor chips may randomly cause the arcing phenomenon, and occurrence of the arcing phenomenon may result in damages of the semiconductor chips. As the arcing phenomenon lasts for an extremely short duration and occurrence of the arcing phenomenon is unpredictable, there is a potential risk that the arcing phenomenon results in malfunction of the semiconductor chips.

### SUMMARY OF THE INVENTION

The invention is directed to a detection system and associated detection method for detecting arcing phenomenon in a chamber where semiconductor chips are manufactured.

According to a first aspect of the present invention, a detection system for detecting an arcing phenomenon in a chamber is provided. In the chamber, a plurality of semiconductor chips are manufactured on at least one wafer. The detection system includes a control circuit and at least one optical sensor being placed in the chamber. The at least one optical sensor is configured for detecting intensity of light signal in the chamber and accordingly generating a plurality of intensity detected results. The light signal continuously lasts in the chamber while the plurality of semiconductor chips are manufactured. The control circuit is in communication with the at least one optical sensor. The control circuit is configured for identifying whether the arcing phenomenon occurred according to the plurality of intensity detected results.

According to a second aspect of the present invention, a detection method for detecting an arcing phenomenon in a chamber is provided. In the chamber, a plurality of semiconductor chips are manufactured on at least one wafer, and an optical sensor is placed. The detection method includes following steps. Firstly, intensity of light signal is detected in the chamber, and a plurality of intensity detected results are generated accordingly. The light signal continuously lasts in the chamber while the plurality of semiconductor chips are manufactured. Then, whether the arcing phenomenon occurred is identified according to the plurality of intensity detected results.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (prior art) is a schematic diagram illustrating the occurrence of arcing phenomenon during manufacture process of semiconductor chips.

FIG. 2 is a schematic diagram illustrating a detection system capable of detecting the arcing phenomenon according to an embodiment of the present disclosure.

FIG. 3 is a schematic diagram illustrating the occurrence of the arcing phenomenon is accompanied by the generation of the flashlight-like signal.

FIGS. 4A and 4B are schematic diagrams illustrating a shorter exposure duration and a longer exposure duration.

FIGS. 5A, 5B, and 5C are schematic diagrams illustrating how the selection of the exposure duration (ta) and the detection cycle (tb) affects the intensity detected results.

FIG. 6 is a schematic diagram illustrating generation of the intensity detected results.

FIGS. 7A and 7B are schematic diagrams illustrating relevance between the intensity of background light signal and identification of the flashlight-like signal.

FIG. 8A is a schematic diagram illustrating a post-processing approach capable of identifying whether the flashlight-like signal exists in the scenario shown in FIG. 7B.

FIG. 8B is a schematic diagram illustrating another post-processing approach capable of identifying whether the flashlight-like signal exists in the scenario shown in FIG. 7B.

FIG. 9 is a schematic diagram illustrating data amount can be reduced by discarding some of the intensity detected results.

FIGS. 10A, 10B, and 100 are schematic diagrams illustrating the length of the data acquiring period and amount of the intensity detected results to be analyzed.

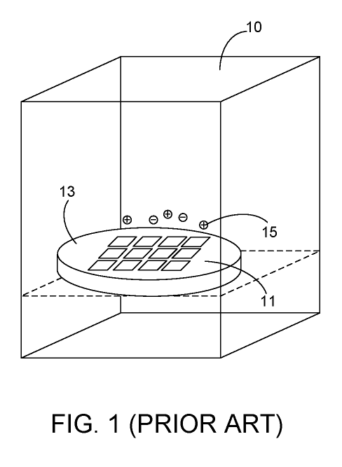

### DETAILED DESCRIPTION OF THE INVENTION

A detection system and associated detection method capable of identifying whether the arcing phenomenon occurs in the chamber are provided in the present disclosure. The occurrence of the arcing phenomenon is accompanied by the generation of the flashlight-like signal, and the detection system and detection method can identify whether the arcing phenomenon occurred accordingly.

When the detection system and detection method confirm that the arcing phenomenon occurred in the chamber while the semiconductor chips are manufactured, there is a chance that the semiconductor chip formed on the wafer at which the arcing phenomenon occurs may be damaged, and further inspection may be performed on the semiconductor chip.

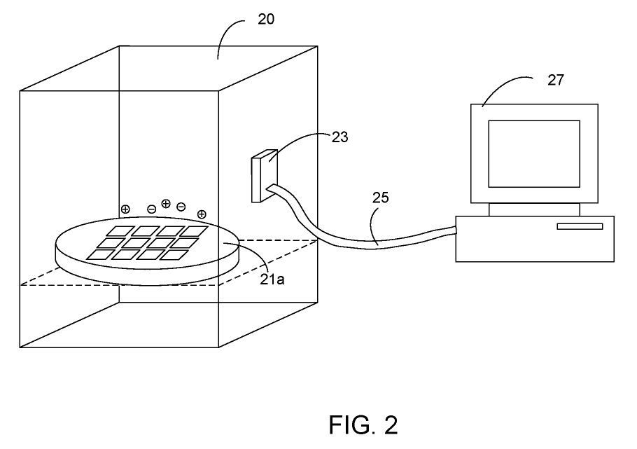

FIG. 2 is a schematic diagram illustrating the detection system capable of detecting the arcing phenomenon according to an embodiment of the present disclosure. The detection system is configured for detecting an arcing phenomenon in a chamber, in which semiconductor chips are manufactured on at least one wafer. The detection system includes at least one optical sensor 23 and a control circuit 27. The optical sensor 23 is placed in the chamber, and the optical sensor 23 is in communication with the control circuit 27.

Light signal continuously lasts in the chamber while semiconductor chips are manufactured. The light signal is related to a flashlight-like signal and a background light signal. The background light signal exists in the chamber all the time, and the flashlight-like signal is generated whenever the arcing phenomenon occurs.

The optical sensor 23 detects the intensity of the light signal in the chamber when semiconductor chips are manufactured. Then, the optical sensor 23 transmits its intensity detected results to the control circuit 27. As the occurrence of the arcing phenomenon results in the generation of the flashlight-like signal and the intensity of the light signal dramatically changes when the flashlight-like signal generates, the detection system can determine the arcing phenomenon does occur if the intensity detected results of the optical sensor 23 have significant fluctuation.

In FIG. 2, the optical sensor 23 and the control circuit 27 are electrically connected to each other through a cable 25. In practical applications, the communication interface between the optical sensor 23 and the control circuit 27 is not limited. For example, the optical sensor 23 and the control circuit 27 may communicate with each other through wireless communication.

Being placed in the chamber 20, the optical sensor 23 continuously or periodically detects or monitors the intensity of light signal lasting in the chamber 20 during the manufacturing procedure of the semiconductor chips. Most of the time, the light signal in the chamber 20 is caused by the background light signal. The light signal in the chamber 20 may further include the flashlight-like signal if the flashlight-like signal is generated.

In short, the intensity detected results generated by the optical sensor 23 include the information about how the intensity of light signal changes with time, and the intensity of light signal dramatically increases if the arcing phenomenon occurs in the chamber 20. Thus, the control circuit 27 can analyze the intensity detected results to identify whether the arcing phenomenon occurred while the semiconductor chips are manufactured.

Alternatively speaking, in a case that the light signal having high intensity level has been detected and recognized, the control circuit 27 confirms that arcing phenomenon occurred in the chamber 20. Otherwise, the control circuit 27 considers that arcing phenomenon does not exist in the chamber.

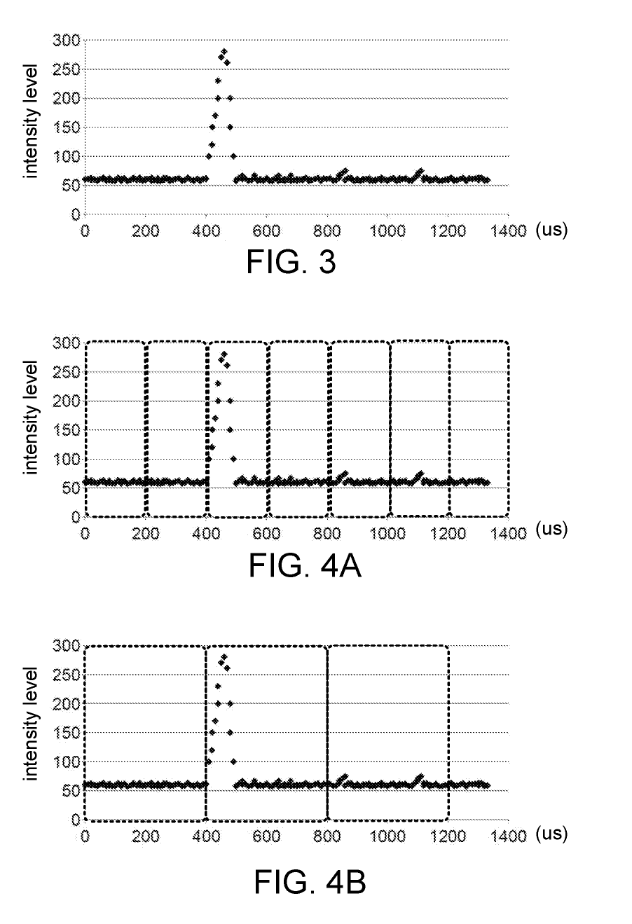

For the sake of illustration, the intensity detected results can be represented in figures. In FIGS. 3, 4A, 4B, 5A, 5B, 5C, 7A, 7B, 8A, 8B, and 9, the vertical axes represent the intensity of the light signal, and the horizontal axes represent time.

FIG. 3 is schematic diagram illustrating the occurrence of the arcing phenomenon is accompanied by the generation of the flashlight-like signal. As shown in FIG. 3, a maximum value (about 270 intensity units) of the intensity detected results occurs between 400 us and 500 us. Therefore, the control circuit 27 can identify that the flashlight-like signal occurs between 400 us and 500 us.

The intensity detected results show that the intensity of the light signal is very low and quite stable before 400 us and after 500 us. Therefore, the control circuit 27 identifies that no flashlight-like signal occurs before 400 us or after 500 us, and the intensity detected results in these durations could reflect the intensity of background light signal in the chamber 20.

According to an embodiment of the present disclosure, a predefined condition can be set in advance. That is, the control circuit can check if the predefined condition is satisfied and identify the arcing phenomenon does occur when the predefined condition is satisfied. The predefined condition can be set based on, for example, absolute values of the intensity detected results or relative values of the intensity detected results.

In some applications, a predefined intensity threshold can be set for directly compared with the intensity detected results. If the intensity of light signal at one or some time points is/are greater than the predefined intensity threshold, the control circuit 27 determines that the predefined condition is satisfied.

In some other applications, a predefined difference threshold can be set for comparing with differences between the intensity detected results and intensity level of the background light signal. If differences between the intensity detected results and the intensity level of background light signal at one or some time points is/are greater than the predefined difference threshold, the control circuit 27 determines that the predefined condition is satisfied.

According to the embodiment of the present disclosure, the control circuit 27 confirms that the flashlight-like signal is generated during the manufacturing procedure, and the arcing phenomenon did occur. In different occasions, values of the predefined intensity threshold and/or the predefined difference threshold can be freely selected and defined.

For example, the predefined intensity threshold may be set as a fixed value in intensity units (for example, 100 intensity units). Alternatively, the predefined intensity threshold can be related to an intensity ratio threshold. That is, the predefined intensity threshold is set to be equivalent to the intensity ratio threshold times an average value of the intensity detected results (or the intensity level of background light signal). The intensity ratio threshold is set to be a value greater than 1 (for example, 1.5).

By determining satisfaction of the predefined condition, the control circuit 27 can identify whether the flashlight-like signal and the arcing phenomenon occurred. In some occasions, all the intensity detected results might be lower than the predefined intensity threshold and the control circuit 27 confirms that no arcing phenomenon occurred in the chamber 20.

The implementation of the optical sensor 23 is not limited. For example, the optical sensor 23 can include a shutter and a sensing component, for example, a photodiode, a photoresistor, a charge-coupled device (hereinafter, CCD), a complementary metal-oxide-semiconductor (hereinafter, CMOS) image sensor, and so forth. The sensing component is used for generating the intensity detected results based on the amount of the light signal passing the shutter when the shutter is open. Same or different types of sensing components may be used together in the detection system.

In addition to the optical sensor, a video recorder may be integrated into the detection system, regardless types of the sensing component. The video recorder is electrically connected to the control circuit 27, for recording video in the chamber while the semiconductor chips are manufactured.

Control of the video recorder can be synchronized with control of the optical sensor 23. That is, the video recorder records the video image during the interval when the optical sensor 23 is in operation. Alternatively, the video recorder may continuously record the video during the whole manufacture procedure.

In a case that occurrence of the arcing phenomenon is confirmed, the recorded video image can be played and further referred by the control circuit 27 to recognize the occurrence position of the arcing phenomenon. Therefore, based on the recorded video image, the semiconductor chip where the arcing phenomenon occurred can be identified, and function of the semiconductor chip can be further inspected.

According to the embodiment of the present disclosure, operation duration of the optical sensor 23 may be adjusted. That is, the control circuit 27 can control the open speed of the shutter. To be more precise, the control circuit 27 opens the shutter for an exposure duration (ta) and closes the shutter for a non-exposure duration, wherein the duration of the arcing phenomenon is shorter than the exposure duration (ta).

Basically, the light signal continually passes the shutter when the shutter is open, and this implies that the sensing component continuously receives the light signal during the exposure duration (ta) and the sensing component generates the intensity detected results based on integrated (accumulated) amount of the light signal passing the shutter during the exposure duration (ta). Therefore, the longer the exposure duration (ta) is, the integrated amount of the intensity of light signal actually detected by the optical sensor 23 is greater.

Please refer to FIGS. 4A and 4B together. FIGS. 4A and 4B are schematic diagrams illustrating a shorter exposure duration and a longer exposure duration. The exposure duration (ta) in FIG. 4A is assumed to be 200 us, and the exposure duration (ta) in FIG. 4B is assumed to be 400 us.

Between 0 us to 200 us, the shutter is open and the intensity of the light signal can be accumulated to obtain a first intensity detected result. Similarly, a second intensity detected result, a third intensity detected result, a fourth intensity detected result, a fifth intensity detected result, and a sixth intensity detected result can be obtained by accumulating amount of the intensity of light signal from 200 us to 400 us, from 400 us to 600 us, from 600 us to 800 us, from 800 us to 1000 us, and from 1000 us to 1200 us, respectively.

In FIG. 4B, the exposure duration (ta) that the shutter is open is longer than the one in FIG. 4A. Between 0 us to 400 us, between 400 us to 800 us, and between 800 us to 1200 us, a first intensity detected result, a second intensity detected result, and a third intensity detected result are generated respectively.

According to FIGS. 4A and 4B, the length of the exposure duration (ta) affects the number of the intensity detected results. The longer the exposure duration (ta) is, the number of the intensity detected results generated by the optical sensor is less.

In addition to the exposure duration (ta), another timing parameter, that is, a detection cycle (tb) is defined to control the open speed of the shutter. The detection cycle (tb) represents the interval that the optical sensor 23 is repetitively enabled. Use of the detection cycle (tb) can lower the frequency that the optical sensor outputs the intensity detected results to the control circuit 27. The duration of the arcing phenomenon is typically in a range of 10 us-100 us, the exposure duration (ta) can be set as 4000 us ( 1/250 s) or slower, and the detection cycle (tb) can be configured, for example, 1/30 second.

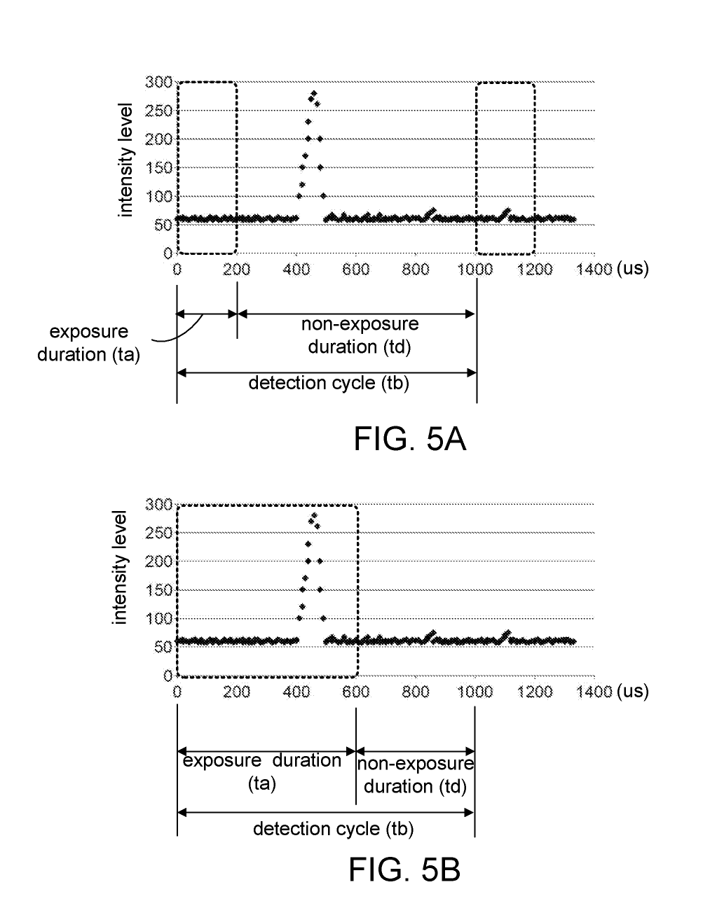

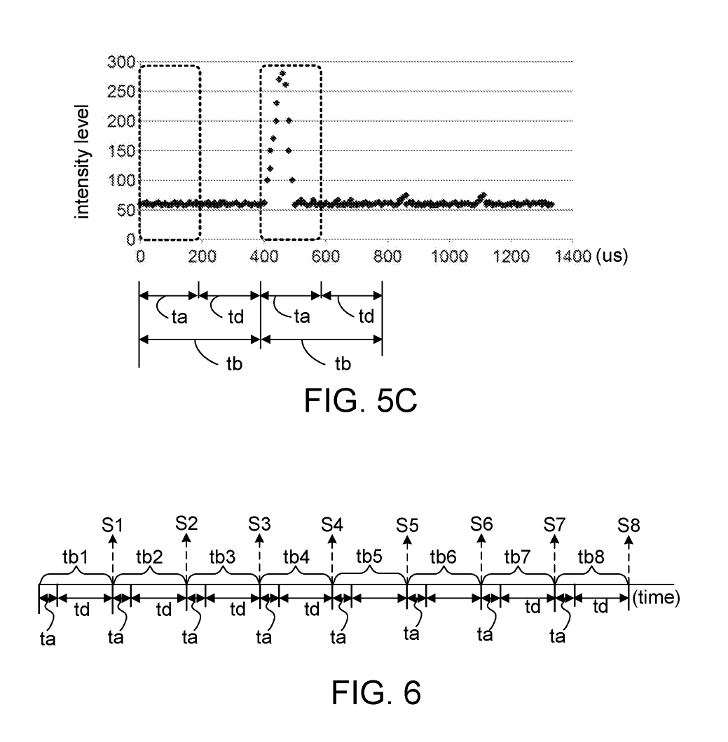

FIGS. 5A, 5B, and 5C are schematic diagrams illustrating how the selection of the exposure duration (ta) and the detection cycle (tb) affects the intensity detected results. In these figures, the optical sensor 23 is turned on periodically according to the detection cycle (tb). The detection cycle (tb) is assumed to include two portions, the exposure duration (ta) and a non-exposure duration (td). During the non-exposure duration (td), the shutter is closed, and the sensing component stops sensing the light signal. In some occasions, the detection cycle (tb) may include only the exposure duration (ta).

In FIG. 5A, the exposure duration (ta) is 200 us, and the detection cycle (tb) is 1000 us. In other words, the optical sensor 23 is turned on for 200 us in every 1000 us. As shown in FIG. 5A, the optical sensor 23 is turned on during 0 us to 200 us, but the flashlight-like signal occurs between 400 us and 500 us, this implies that the exposure duration (ta) in FIG. 5A does not cover the generation of the flashlight-like signal.

Therefore, there is a chance that the optical sensor 23 may miss the duration that the flashlight-like signal generates. The longer the non-exposure duration (td) is, the chance of missing generation the flashlight-like signal becomes higher.

In FIG. 5B, the exposure duration (ta) lasts from 0 us to 600 us, and the detection cycle (tb) is 1000 us. Comparing with FIG. 5A, the exposure duration (ta) in FIG. 5B covers the duration when the flashlight-like signal generates. Therefore, the longer the exposure duration (ta) is, the chance that the optical sensor 23 can successfully detect the flashlight-like signal (so as the arcing phenomenon) is higher. However, the longer exposure duration (ta) represents that shutter of the optical sensor 23 is open for a longer duration, that means noise caused by the background light signal will be increased.

Please refer to FIGS. 5A and 5B together. When the exposure duration (ta) is shorter, the signal to noise ratio (hereinafter, SNR) is greater. Meanwhile, the possibility that flashlight-like signal generates in the non-exposure duration (td) becomes higher, and the chance that optical sensor 23 may miss detecting the flashlight-like signal becomes higher. On the other hand, when the exposure duration (ta) is longer, the SNR is lower. Meanwhile, the possibility that flash-like signal generates in the non-exposure duration (td) becomes lower, and the chance that the flashlight-like signal can be successfully acquired becomes higher.

Therefore, extending or shortening length of the exposure duration (ta) has both advantages and drawbacks, and selection of the exposure duration (ta) becomes a dilemma. In practical application, selection of the exposure duration (ta) can be determined based on different considerations. For example, depending on the chance and frequency that the arcing phenomena may occur, the exposure duration (ta) can be determined or selected.

If the chance that the arcing phenomenon may occur is higher, the arcing phenomena may occur in a relatively frequent manner, and the optical sensor has many chances to detect the arcing phenomena. In short, even if some of the arcing phenomena occur in the non-exposure durations (td), some other arcing phenomena may still occur during the exposure durations (ta). In other words, when the arcing phenomena may highly likely occur in the manufacturing procedure or in a certain stage of the manufacturing procedure, the exposure duration (ta) of the optical sensor can be set to a shorter interval and/or the detection cycle (tb) can be set to a longer interval.

In FIG. 5C, the exposure duration (ta) is 200 us, and the detection cycle (tb) is 400 us. Comparing with FIG. 5A, the second exposure duration (ta) in FIG. 5C, between 400 us and 600 us, also covers the duration of the flashlight-like signal. Therefore, the shorter the detection cycle (tb) is, the chance that the optical sensor 23 can successfully detect the flashlight-like signal (so as the arcing phenomenon) is higher. However, the shorter detection cycle (tb) also represents that shutter of the optical sensor 23 is open more frequently, and the amount of intensity detected results increases.

Based on FIGS. 5A, 5B, and 5C, extension and/or shortening of the exposure duration (ta) and the detection cycle (tb) bring side effects. Therefore, determination of values of the exposure duration (ta) and the detection cycle (tb) need trade-off.

FIG. 6 is a schematic diagram illustrating generation of the intensity detected results. Several continuous detection cycles (tb1, tb2, . . . tb8) are shown, and each of the detection cycles tb1, tb2, . . . tb8 includes the exposure duration (ta) and the non-exposure duration (td). In practical applications, starting timepoint of the exposure durations (ta) is not limited to be at the starting timepoint of the detection cycles (tb1, tb2, . . . tb8).

As shown in FIG. 6, each of the detection cycles (tb1, tb2, . . . tb8) is corresponding to an intensity detected result S. The exposure duration (ta) in detection cycle (tb1) is corresponding to intensity detected result (S1), the exposure duration (ta) in detection cycle (tb2) is corresponding to intensity detected result S2, and so forth.

In FIG. 6, it is assumed that the optical sensor 23 outputs the intensity detected results (S1˜S8) to the control circuit 27 at the end of the detection cycles (tb1, tb2, . . . tb8). Or, in some applications, the optical sensor 23 may transmit intensity detected results (S1˜S8) to the control circuit 27 at the end of the exposure durations (ta of tb1, ta of tb2 . . . and so forth), that is, before the detection cycles (tb1, tb2, . . . tb8). end.

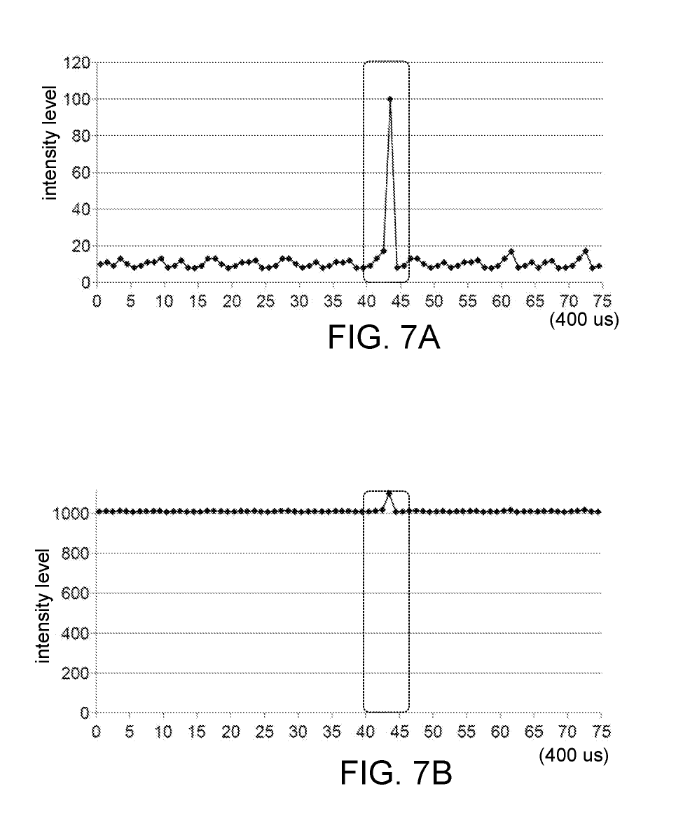

Each of these intensities detected results (S1, . . . , S8) can be represented as a data point in FIGS. 7A and 7B, and the detection cycle (tb) shown in FIG. 5C is further adopted. Therefore, in FIGS. 7A and 7B, the intervals between data points are corresponding to 400 us. Later, the intensity detected results (S1, . . . S8) as shown in data points are processed and analyzed by the control circuit 27.

FIGS. 7A and 7B are schematic diagrams illustrating relevance between the intensity of background light signal and identification of the flashlight-like signal. The dotted lines shown in FIGS. 7A and 7B are corresponding the durations when the flashlight-like signal generates. FIG. 7A is corresponding to the case that the background light signal has low intensity level, and FIG. 7B is corresponding to the case that the background light signal has high intensity level.

As shown in FIG. 7A, the highest intensity level of the flashlight-like signal is about 100 intensity units, and the intensity level of background light signal is less than 20 intensity units. Therefore, in FIG. 7A, the maximum intensity level of the flashlight-like signal is about 10 times of the intensity level of background light signal.

As shown in FIG. 7B, the intensity level of flashlight-like signal is about 1100 intensity units, and the intensity level of background light signal is about 1000 intensity units. Therefore, in FIG. 7B, the intensity level of the flashlight-like signal is about 1.1 times of the intensity level of background light signal.

In some applications, identification of the flash-light signal may depend on some environmental conditions, for example, the intensity of background light signal. When the intensity of background light signal is much lower than the intensity of the flashlight-like signal (as shown in FIG. 7A), the control circuit 27 can easily identify the generation of the flashlight-like signal. When the intensity of background light signal is close to the intensity of the flashlight-like signal (as shown in FIG. 7B), the control circuit 27 needs to further analyze the detected results, and a post-processing procedure can be performed. Depending on differences between the intensity of background light signal and the flashlight-like signals, the control circuit 27 may utilize different post-processing approaches to identify the flashlight-like signal.

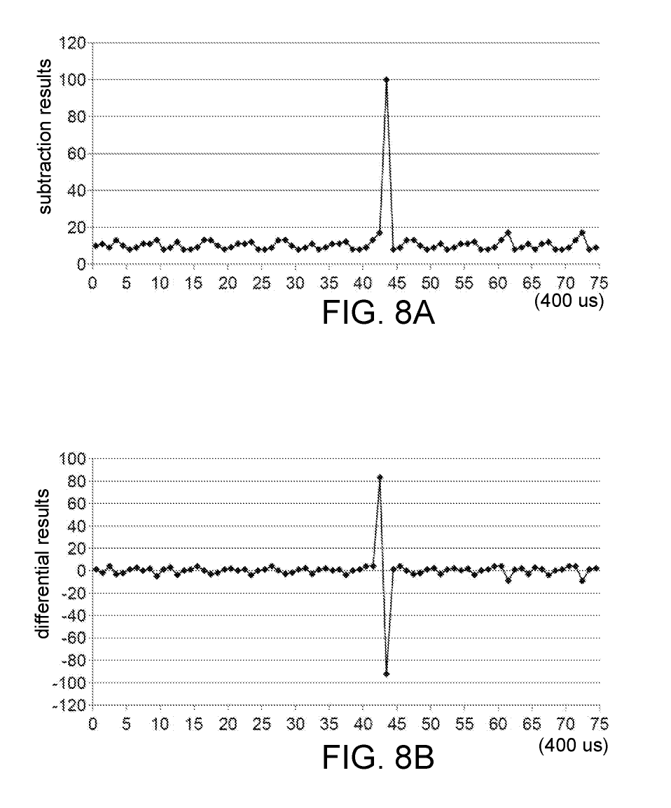

FIGS. 8A and 8B are examples showing how post-processing approaches can be used for the scenario shown in FIG. 7B. According to the embodiment of the present disclosure, the control circuit 27 may perform a subtraction calculation (FIG. 8A) or a differentiating calculation (FIG. 8B) to the intensity detected results when the intensity detected results show that the intensity level of the background light signal is high.

FIG. 8A is a schematic diagram illustrating a post-processing approach capable of identifying whether the flashlight-like signal exists in the scenario shown in FIG. 7B. During the post-processing, the control circuit 27 subtracts each of the intensity detected results with the intensity level of the background light signal (for example, 1000 intensity units) to obtain intensity subtraction results.

Then, the control circuit 27 identifies whether the predefined condition is satisfied based on the intensity subtraction results. For example, the predefined condition is determined to be satisfied when a maximum value exists among the intensity subtraction results.

FIG. 8B is a schematic diagram illustrating another post-processing approach capable of identifying whether the flashlight-like signal exists in the scenario shown in FIG. 7B. During the post-processing, the control circuit 27 differentiates the intensity detected results to obtain intensity differential results.

Then, the control circuit 27 identifies whether the predefined condition is satisfied based on the intensity differential results. For example, the predefined condition is determined to be satisfied when a maximum value exists among the intensity differential results.

According to the embodiment of the present disclosure, the detection system may further include a storage circuit being in communication with the control circuit 27. The storage circuit can be configured to receive and save the intensity detected results during the manufacturing procedure.

To save the storage space required for saving the intensity detected results, the control circuit 27 may control the storage circuit not to save all the intensity detected results. That is, as the occurrence chance of the arcing phenomenon is not high, repetitively saving and processing the intensity detected results consume numerous amounts of space and time.

According to the embodiment of the present disclosure, a data acquiring period (tc) greater than or equivalent to the detection cycle (tb) can be defined to reduce the amount of the intensity detected results of the optical sensor 23 to be processed by the control circuit 27. The control circuit 27 stores at least one of the intensity detected results to the storage circuit in every data acquiring period (tc).

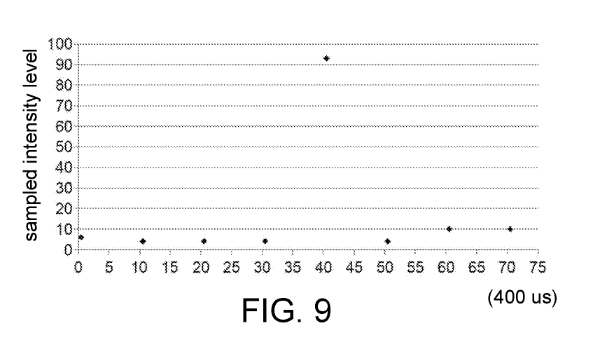

FIG. 9 is a schematic diagram illustrating data amount can be reduced by discarding some of the intensity detected results. In order to improve the efficiency of the detection system, the control circuit 27 may perform preliminary analyses of the intensity detected results. As the optical sensor may generate a large amount of the intensity detected results as raw data, performing preliminary analyses (for example, the preliminary comparison between the intensity detected results) can help the control circuit 27 to reduce the data amount need to be stored.

In FIG. 9, it is assumed that a maximum value of every 10 raw data (intensity detected results being generated and outputted by the optical sensor 23) is acquired and saved. Therefore, only the maximum of the intensity detected results being detected between 0 us to 10*400 us is saved, and other intensity detected results being detected between 0 us to 10*400 us are discarded. Similarly, only the maximum of the intensity detected result being detected between 10*400 us to 20*400 us is saved, and other intensity detected results being detected between 10*400 us to 20*400 us are discarded.

By doing so, only one of every ten intensity detected results is saved and need further processing from the control circuit 27. In practical application, detail implementation about the preliminary analyses should not be limited. For example, it is possible to select and store two or more intensity detected results in every data acquiring period (tc).

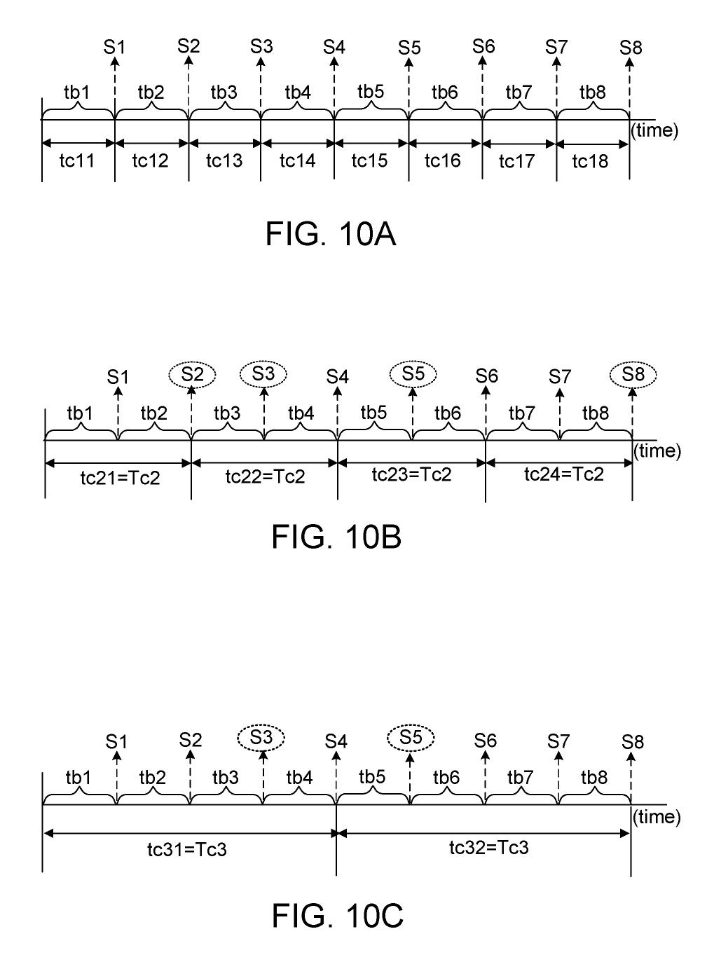

FIGS. 10A, 10B, and 100 are schematic diagrams illustrating the length of the data acquiring period and amount of the intensity detected results to be analyzed. In FIGS. 10A, 10B, and 100, different lengths of the data acquiring period (tc1, tc2, tc3) are shown, and notations and meanings of the detection cycles (tb1, tb2, . . . tb8) and the intensity detected results (S1, S2 . . . S8) are the same as the ones in FIG. 6.

The data acquiring period (tc) may be equivalent to one or more detection cycles (tb). The data acquiring periods (tc11, tc12 . . . tc18) in FIG. 10A are assumed to be equivalent to the detection cycles (tb1, tb2, . . . tb8). The data acquiring periods (tc21, tc22 . . . tc24) in FIG. 10B are assumed to be equivalent to two times of the detection cycles (tb1, tb2, . . . tb8), and the data acquiring period (tc31, tc32) in FIG. 100 are assumed to be equivalent to four times of the detection cycles (tb1, tb2, . . . tb8).

In FIG. 10A, each of the data acquiring periods (tc11, tc12, . . . tc18) includes only one detection cycle (tb1, tb2, . . . tb8), and the control circuit 27 saves all the intensity detected results (S1, S2 . . . S8) to the storage circuit.

In FIG. 10B, each of the data acquiring periods (tc21, tc22, tc23, tc24) includes two detection cycles (tb). For example, the data acquiring period (tc21) includes detection cycles (tb1, tb2), the data acquiring period (tc22) includes detection cycles (tb3, tb4), and so forth. As each of the data acquiring periods (tc21, tc22, tc23, tc24) includes two detection cycles (Tc2=2*tb), each of the data acquiring periods (tc21, tc22, tc23, tc24) corresponds to two intensity detected results.

According to the embodiment of the present disclosure, the intensity detected results S1, S2 are compared by the control circuit 27 to determine which has the greater value, and only the one having the greater value is selected as being corresponding to the data acquiring period (tc21) and saved to the storage circuit. In FIG. 10B, the intensity detected results being circled by the dotted circles are assumed to be the ones having greater values.

Therefore, the storage circuit stores the intensity detected result S2 as the intensity detected result is corresponding to the data acquiring period (tc21), stores the intensity detected result S3 as the intensity detected result is corresponding to the data acquiring period (tc22), and so forth. In short, the control circuit 27 selects only half of the intensity detected results to be stored in the storage circuit.

In FIG. 100, each of the data acquiring periods (tc31, tc32) includes four detection cycles (tb1˜tb4, tb5˜tb8), that is, Tc3=4*tb. Therefore, the control circuit 27 selects the maximum value among the four intensity detected results (S1, S2, S3, S4) as the one corresponding to the data acquiring period (tc31), and the control circuit 27 selects the maximum value among the four intensity detected results (S5, S6, S7, S8) as the one corresponding to the data acquiring period (tc32).

In FIG. 100, the storage circuit stores the intensity detected result S3 as the intensity detected result is corresponding to the data acquiring period (tc31), and stores the intensity detected result S5 as the intensity detected result is corresponding to the data acquiring period (tc32). In short, only one quarter of the intensity detected results are stored.

Therefore, when the data acquiring period (tc) is longer than the detection cycle (tb), the amount of the intensity detected results being actually analyzed by the control circuit 27 can be reduced.

As illustrated above, the detection system and the detection method can effectively monitor status in the chamber, and the arcing phenomenon can be accurately detected. Moreover, the exposure duration (ta), the detection cycle (tb), and the data acquiring period (tc) can be defined, and use of different settings of these timing parameters allows the detection system to effectively acquire intensity detected results. Among these timing parameters, the exposure duration (ta) and the detection cycle (tb) are related to detection operation of the optical sensor 23, and the data acquiring period (tc) is related to the data processing of the control circuit 27.

The timing parameters in the detection system are tunable. For example, the detection cycle (tb) before the plasma process can be set to be longer than the detection cycle (tb) during or after the plasma process because the chance that the plasma procedure causes unequally distributed charges is higher. Therefore, the application of the detection system and the detection method is very flexible.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A detection system for detecting an arcing phenomenon in a chamber, in which a plurality of semiconductor chips are manufactured on at least one wafer, wherein the detection system comprises:
at least one optical sensor, being placed in the chamber, configured for detecting intensity of light signal in the chamber and accordingly generating a plurality of intensity detected results, wherein the light signal continuously lasts in the chamber while the plurality of semiconductor chips are manufactured; and
a control circuit, in communication with the at least one optical sensor, configured for identifying whether the arcing phenomenon occurred according to the plurality of intensity detected results.

2. The detection system according to claim 1, wherein the light signal is related to a flashlight-like signal and a background light signal, and intensity level of the flashlight-like signal is greater than intensity level of the background light signal.

3. The detection system according to claim 2, wherein the control circuit confirms that the arcing phenomenon produces the flashlight-like signal when a predefined condition is satisfied.

4. The detection system according to claim 3, wherein the predefined condition is satisfied if any of the plurality of intensity detected results is greater than or equivalent to a predefined intensity threshold.

5. The detection system according to claim 3, wherein the predefined condition is satisfied if any of differences between the plurality of intensity detected results and the intensity level of the background light signal is greater than or equivalent to a predefined difference threshold.

6. The detection system according to claim 3, wherein the control circuit performs post-processing to the plurality of intensity detected results when the plurality of intensity detected results show that the intensity level of the background light signal is high.

7. The detection system according to claim 6, wherein during the post-processing,
the control circuit subtracts each of the plurality of intensity detected results with the intensity level of the background light signal to obtain a plurality of intensity subtraction results, and
the control circuit identifies whether the predefined condition is satisfied based on the plurality of intensity subtraction results.

8. The detection system according to claim 6, wherein during the post-processing,
the control circuit differentiates the plurality of intensity detected results to obtain a plurality of intensity differential results, and
the control circuit identifies whether the predefined condition is satisfied based on the plurality of intensity differential results.

9. The detection system according to claim 1, wherein each of the at least one optical sensor comprises:
a shutter, electrically connected to the control circuit, wherein the control circuit controls open speed of the shutter, and the light signal passes the shutter when the shutter is open; and
a sensing component, electrically connected to the shutter and the control circuit, for generating the plurality of intensity detected results based on integrated amount of the light signal passing the shutter during an exposure duration, wherein duration of the arcing phenomenon is shorter than the exposure duration.

10. The detection system according to claim 9, wherein the sensing component is a photodiode, a photoresistor, a charge-coupled device, or a complementary metal-oxide-semiconductor image sensor.

11. The detection system according to claim 9, wherein the control circuit opens the shutter for the exposure duration and closes the shutter for a non-exposure duration.

12. The detection system according to claim 11, further comprises:
a storage circuit, in communication with the control circuit, configured for storing at least one of the plurality of intensity detected results in every data acquiring period, wherein summation of the exposure duration and the no-exposure duration is defined as a detection cycle, and the data acquiring period is longer than or equivalent to the detection cycle.

13. The detection system according to claim 3, further comprises:
a video recorder, electrically connected to the control circuit, for recording video in the chamber while the plurality of semiconductor chips are manufactured, wherein the control circuit recognizes position where the arcing phenomenon occurred based on the recorded video when the predefined condition is satisfied.

14. A detection method for detecting an arcing phenomenon in a chamber, in which a plurality of semiconductor chips are manufactured on at least one wafer and an optical sensor is placed, wherein the detection method comprises steps of:
detecting intensity of light signal in the chamber and accordingly generating a plurality of intensity detected results by the optical sensor, wherein the light signal continuously lasts in the chamber while the plurality of semiconductor chips are manufactured; and
identifying whether the arcing phenomenon occurred according to the plurality of intensity detected results.

15. The detection method according to claim 14, wherein the light signal is related to a flashlight-like signal and a background light signal, and intensity level of the flashlight-like signal is greater than intensity level of the background light signal.

16. The detection method according to claim 15, wherein the step of identifying whether the arcing phenomenon occurred according to the plurality of intensity detected results indicates that
confirming that the arcing phenomenon produces the flashlight-like signal when a predefined condition is satisfied.

17. The detection method according to claim 16, wherein
the predefined condition is satisfied if any of the plurality of intensity detected results is greater than or equivalent to a predefined intensity threshold; or
the predefined condition is satisfied if any of differences between the plurality of intensity detected results and the intensity level of the background light signal is greater than or equivalent to a predefined difference threshold.

18. The detection method according to claim 16, further comprising a step of:
performing a post-processing to the plurality of intensity detected results when the plurality of intensity detected results show that the intensity level of the background light signal is high.

19. The detection method according to claim 18, wherein the step of identifying whether the arcing phenomenon occurred according to the plurality of intensity detected results further comprising steps of:
subtracting each of the plurality of intensity detected results with the intensity level of background light signal to obtain a plurality of subtraction results during the post-processing, and identifying whether the predefined condition is satisfied based on the plurality of intensity subtraction results; or
differentiating the plurality of intensity detected results to obtain a plurality of differential results during the post-processing, and identifying whether the predefined condition is satisfied based on the plurality of intensity differential results.

20. The detection method according to claim 16, wherein the step of detecting the intensity level of the light signal in the chamber and accordingly generating the plurality of intensity detected results further comprises steps of:
controlling open speed of a shutter of the optical sensor, wherein the light signal passes the shutter when the shutter is open, wherein the shutter is open for an exposure duration and closed for a non-exposure duration, and duration of the arcing phenomenon is shorter than the exposure duration; and
generating the plurality of intensity detected results based on integrated amount of the light signal passing the shutter during the exposure duration.
